(19) United States
(12) Patent Application Publication
(10) Pub. No.: US 2016/0133367 A1
(43) Pub. Date: May 12, 2016

(54) METHODS AND SYSTEMS FOR FABRICATING AMORPHOUS RIBBON ASSEMBLY COMPONENTS FOR STACKED TRANSFORMER CORES

(71) Applicant: LAKEVIEW METALS, INC., Antioch, IL (US)

(72) Inventor: Kevin C. Looby, Wadsworth, IL (US)

(21) Appl. No.: 14/935,737

(22) Filed: Nov. 9, 2015

Related U.S. Application Data
(60) Provisional application No. 62/077,524, filed on Nov. 10, 2014.

(51) Int. Cl. H01F 1/153; H01F 27/26; H01F 27/25

(52) U.S. Cl. CPC H01F 1/153; H01F 27/25; H01F 27/263

(57) ABSTRACT

An amorphous ribbon assembly component for use with an amorphous metallic transformer core. The assembly component comprising a first collection of pre-annealed amorphous metal ribbons, and an amount of a first stacking material provided between a first amorphous metal ribbon in the first collection of pre-annealed amorphous metal ribbons and a second amorphous metal ribbon in the first collection of pre-annealed amorphous metal ribbons. The second amorphous metal ribbon residing adjacent the first amorphous metal ribbon. The amount of the stacking material defines a predefined stacking factor of an overall stacking height defined by the assembly component. The assembly component may comprise a transformer yoke portion, such as a transformer upper yoke portion.

### CROSS REFERENCE TO RELATED APPLICATIONS

The present application claims priority to U.S. Provisional Application No. 62/077,524, filed Nov. 10, 2014, which is herewith incorporated by reference into the present application.

### FIELD OF THE INVENTION

The present disclosure is generally directed to fabricating a transformer core comprising pre-annealed amorphous metal ribbons. Specifically, the present disclosure is generally directed to methods and/or systems for fabricating a transformer core comprising stacked, pre-annealed metallic ribbon packets or groups, wherein each packet or group comprises a plurality of thin pre-annealed amorphous metal ribbons.

### BACKGROUND

Electrical-power transformers are used in various electrical and electronic applications. For example, as is generally known in the art, transformers transfer electric energy from one circuit to another circuit through magnetic induction. Transformers are also utilized to step electrical voltages up or down, to couple signal energy from one stage to another, and to match the impedances of interconnected electrical or electronic components. Transformers may also be used to sense current, and to power electronic trip units for circuit interrupters. Still further, transformers may also be employed in solenoid-equipped magnetic circuits, and in electric motors.

A typical transformer includes two or more multi-turned coils of wire commonly referred to as “phase windings.” The phase windings are placed in close proximity to one another so that the magnetic fields generated by each winding are coupled when the transformer is energized. Most transformers have a primary winding and a secondary winding. The output voltage of a transformer can be increased or decreased by varying the number of turns in the primary winding in relation to the number of turns in the secondary winding.

The magnetic field generated by the current passing through the primary winding is typically concentrated by winding the primary and secondary coils on a core of magnetic material. This arrangement increases the level of induction in the primary and secondary windings so that the windings can be formed from a smaller number of turns while still maintaining a given level of magnetic-flux. In addition, the use of a magnetic core having a continuous magnetic path helps to ensure that virtually all of the magnetic field established by the current in the primary winding is induced in the secondary winding. An alternating current flows through the primary winding when an alternating voltage is applied to the winding. The value of this current is limited by the level of induction in the winding.

The current produces an alternating magnetomotive force that, in turn, creates an alternating magnetic flux. The magnetic flux is constrained within the core of the transformer and induces a voltage across the secondary winding. This voltage produces an alternating current when the secondary winding is connected to an electrical load. The load current in the secondary winding produces its own magnetomotive force that, in turn, creates a further alternating flux that is magnetically coupled to the primary winding. A load current then flows in the primary winding. This current is of sufficient magnitude to balance the magnetomotive force produced by the secondary load current. Thus, the primary winding carries both magnetizing and load currents, the secondary winding carries a load current, and the core carries only the flux produced by the magnetizing current.

Certain modern transformers generally operate with a high degree of efficiency. Magnetic devices such as transformers, however, undergo certain losses because some portion of the input energy to the transformer is inevitably converted into unwanted losses such as heat. One type of unwanted heat generation is ohmic heating—heating that occurs in the phase windings due to the resistance of the windings.

Traditionally, transformer cores have been formed of grain oriented silicon steel laminations. However, improvements have been made in such grained oriented steels to permit reductions in transformer core sizes, manufacturing costs and the losses introduced into an electrical distribution system by the transformer core. As the cost of electrical energy continues to rise, reductions in core loss have become an increasingly important design consideration in all sizes of electrical transformers.

In order to further reduce these performance losses in transformers, amorphous metals having a non-crystalline structure, lower iron losses and higher permeability, have been used in forming electromagnetic devices, such as amorphous metal cores that can be used for electrical transformers. Generally, amorphous metals have been used because of their superior electrical characteristics relative to grain oriented silicon steel laminations. For this reason, amorphous ferromagnetic materials are being used more and more frequently as transformer base core materials in order to reduce undesired transformer core operating losses.

Certain known methods and/or systems for manufacturing stacked transformer cores comprising grain oriented steel materials are known. Certain electrical induction apparatus, such as transformers and the like, are provided with a magnetic core constructed with a plurality of stacked layers of laminations. The laminations are formed from a magnetic material to provide a path for magnetic flux. One common way to make such a core is to use magnetic strip material having a preferred direction of orientation parallel to the longitudinal direction of the material, for example, a non-amorphous material such as grain-oriented steel.

A stacked transformer core is comprised of thin metallic laminate plates, such as grain oriented silicon steel. Typically, this type of material is used because the grain of the steel may be groomed in certain directions to reduce the magnetic field loss. The collection or grouping of plates are stacked on top of each other to form a plurality of staggered steps or staggered layers, i.e., they are offset from one another.

As such, a stacked core is typically rectangular in shape and can have a rectangular or cruciform cross-section. One advantage of using a stacked arrangement comprising a cruciform cross-section is that such a stacked arrangement increases the strength of a stacked core. In addition, a core leg having a cruciform cross-section provides more surface area for supporting a coil. An example of a conventional stacked transformer core having a cruciform cross-section is shown in U.S. Pat. No. 4,283,842 to DeLaurentis et al, herein incorporated by reference and to which the reader is directed to for further information.

One of the challenges faced by manufacturers of stacked amorphous transformer cores has to do with the nature of the amorphous metal ribbons themselves. For example, due to the nature of the manufacturing process, an amorphous ferromagnetic ribbon suitable for use in a distribution transformer core is extremely thin. For example, the thickness of a typical amorphous metallic ribbon may nominally be on the order of 0.23 mm versus a thickness of approximately 0.250 mm for typical grain oriented silicon steel.

Moreover, such amorphous metallic ribbons are quite brittle and are therefore easily damaged or fractured during the processing, the annealing, and the handling of such ribbons. Consequently, the handling, processing, fabrication, annealing, and shaping of amorphous metallic transformer cores present certain unique challenges of handling the very thin ribbons, particularly when fabricating the various amorphous ribbon packets or groupings and therefore also when arranging such packets or groupings into a stacked core.

Another such fabricating challenge relates to the magnetic properties of the amorphous metals which have been found to be deleteriously affected by mechanical stresses. Such mechanical stresses may be introduced during the fabricating and finishing steps of winding, forming, and final shaping (via conventional epoxy or tape procedures) the amorphous metal groupings and stacks into a desired core shape.

As just one example, of particular importance is the process of lacing the top yoke after the coils have been placed over the core legs. This transformer lacing step must be performed with upmost care and diligence in an attempt to avoid permanently deforming the core from its electrical tested condition and after the stacked core has been laced into the coil window. That is, if the stacked core is not returned to its originally tested orientation, stresses may be introduced onto the amorphous metallic ribbons making up the core during the lacing procedure. Consequently, if there are significant stresses remaining after lacing, the low core loss characteristic offered by the amorphous metal core material is diminished. Since amorphous metal laminations are quite weak and have little resiliency, they can be readily disoriented during the lacing step, resulting in core performance degradation if not corrected. Additionally, because each amorphous ribbon has a thickness of less than approximately 0.1 mm, and little rigidity, handling sheets individually is not very practical.

There is, therefore, a need for a more cost effective and less labor intensive method of fabricating an annealed amorphous stacked core. Such a desired cost effective and less labor intensive stacked core method should also offer a certain desired degree of core component rigidity and containment while also increasing overall manufacturing facility throughput while still trying to reduce scrap, waste, and/or rework.

These as well as other advantages of various aspects of the present disclosure will become apparent to those of ordinary skill in the art by reading the following detailed description, with appropriate reference to the accompanying drawings.

### SUMMARY

According to an exemplary embodiment, an amorphous ribbon assembly component for use with an amorphous metallic transformer core is provided. The assembly component comprising a first collection of pre-annealed amorphous metal ribbons, and an amount of a first stacking material provided between a first amorphous metal ribbon in the first collection of pre-annealed amorphous metal ribbons and a second amorphous metal ribbon in the first collection of pre-annealed amorphous metal ribbons. The second amorphous metal ribbon residing adjacent the first amorphous metal ribbon. The amount of the stacking material defines a predefined stacking factor of an overall stacking height defined by the assembly component. The assembly component may comprise a transformer yoke portion, such as a transformer upper yoke portion.

These as well as other advantages of various aspects of the present patent disclosure will become apparent to those of ordinary skill in the art by reading the following detailed description, with appropriate reference to the accompanying drawings.

### BRIEF DESCRIPTION OF THE FIGURES

Exemplary embodiments are described herein with reference to the drawings, in which:

FIG. 1 illustrates a perspective view of a stacked magnetic core transformer constructed in accordance with this disclosure;

FIG. 2 illustrates a perspective view of a stacked magnetic core constructed in accordance with this disclosure, and one that might be used with the transformer illustrated in FIG. 1;

FIG. 3 illustrates a side view of one of the stacked transformer core assembly components positioned within a coil, such as one of the coils illustrated in the transformer illustrated in FIG. 1;

FIG. 4 illustrates yet another side view of one of the stacked transformer core assembly components illustrated in the transformer illustrated in FIG. 1;

FIG. 5 illustrates various amorphous ribbon stacked transformer configurations according to this disclosure;

FIG. 6 illustrates certain process steps for fabricating an amorphous ribbon assembly component, such as one of the assembly components illustrated in FIGS. 1 and 2;

FIG. 8 is a diagram illustrating a computerized stacking system for fabricating a an assembly component for use in a stacked amorphous transformer core, such as one of the assembly components illustrated in FIGS. 1 and 2.

### DETAILED DESCRIPTION

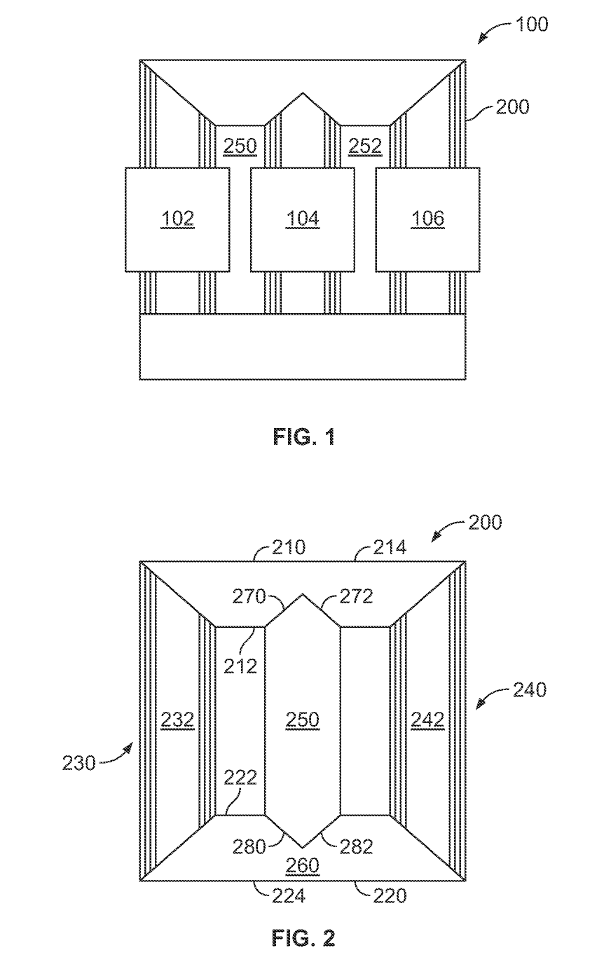

The present disclosure is generally directed to methods and systems for fabricating pre-annealed amorphous ribbon assembly components for an amorphous core that can be used to fabricate amorphous transformers, such as the transformer 100 as illustrated in FIG. 1. As illustrated, the transformer 100 comprises a stacked amorphous core 200 and three coils 102, 104, and 106. As will be explained in greater detail below, the stacked amorphous ribbon core 200 comprises a build up of various packets or groupings of pre-annealed amorphous ribbon stacked upon one another in a predetermined orientation so as to achieve a certain predefined overall height or stacking factor. In other words, prior to assembly or fabrication of the stacked amorphous core 200, the amorphous metal ribbons that make up each packet or grouping in the core will be annealed, such as by way of the annealing process discussed in the patent document WO 2011/060546 entitled “System And Method For Treating An Amorphous Alloy Ribbon,” herein entirely incorporated by reference and to which the reader is directed to for further information.

Importantly, and as described in greater detail below, one or more of the plurality of core packets or core groupings comprise a plurality of pre-annealed amorphous ribbons separated by a plurality of spacers such that one or more of the core packets or groupings making up the stacked core 200 are configured to define a predetermined stacking factor so as to define a predefined overall height of the resulting stacked transformer core.

In one aspect, the amorphous transformer 100 may comprise an oil-filled transformer, i.e., cooled by oil, or a dry-type transformer, i.e., cooled by air. The construction of the amorphous core 200, however, is especially suitable for use in a dry transformer utilizing a stepped transformer core construction. As those of ordinary skill in the art will recognize, a stepped transformer core construction is generally used because low-voltage and high-voltage coils are circular and the core comprises a stepped or cruciform arrangement for better utilization of the space within the coil and for reducing the means length of the low-voltage and high-voltage turns of the coil, thereby resulting in certain coil material (i.e., copper) cost savings.

Referring now to FIGS. 1 and 2, in one arrangement, the amorphous core 200 comprises a rectangular shape. As illustrated, this rectangular shaped amorphous core 200 generally comprises multiple amorphous ribbon assembly components. Specifically, this amorphous core comprises five (5) amorphous ribbon assembly components such as an upper yoke portion 210, a lower yoke portion 220, a first outer limb or leg 230, and a second outer limb or leg 240. In addition, the amorphous ribbon core 200 further comprises a third or main limb or leg 250. As illustrated, an upper end portion of the first and second outer legs 230, 240 is fabricated so as to connect to first and second ends of the upper portion 210, respectively. In a similar fashion, a lower end portion of the first and second outer legs 230, 240 is fabricated so as to connect to first and second ends of the lower portion 220.

In this preferred arrangement, the third or middle leg 250 may be disposed midway between the first and second outer legs 230, 240. The third or middle leg 250 comprises an upper end fabricated so as to connect to the upper yoke portion 210 and a lower end fabricated so as to connect to the lower yoke portion 220. With this construction, a first and a second window 250, 252 are formed residing between the middle leg 250 and the first and second outer legs 230, 240, respectively.

As illustrated, in one preferred arrangement, the stacked magnetic core 200 comprises a butt-lap type of joint, such as the butt-lap type joint disclosed in U.S. Pat. No. 2,300,964, herein entirely incorporated by reference and to which the reader is further directed for further information. In such a butt-lap joint, the ends of the various amorphous ribbon assembly components may be mitered and then butted together so as to form diagonal joints. Specifically, the first and second legs 230, 240 and the upper and bottom yoke portions 210, 220 are mitered and butted together to form diagonal joints between the laminations, in each layer of laminations. In principle, the joints in alternate layers are aligned, and offset from aligned joints in the intervening layers.

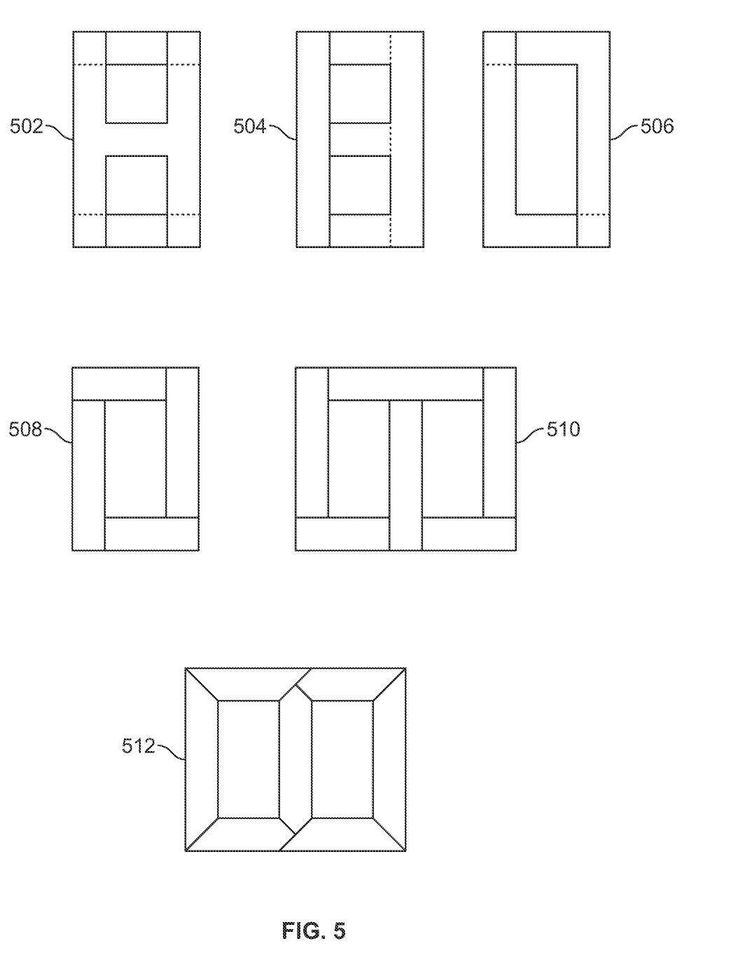

Although the core arrangement illustrative in FIG. 2 illustrates a butt joint configuration, alternative joint configurations may also be used either mitered joints or non-mitered joints. As just a few examples, and as illustrated in FIG. 5, such alternative joint configurations may comprise such as H-I plate core, an E-I plate core, an L-plate core, an I-plate core, or a mitered core. As one of skill in the art will recognize, the overall amorphous core construction mainly depends on technical specifications manufacturing limitations, and transport considerations

Returning to FIGS. 1 and 2, the upper yoke portion 210 comprises an inner side 212 and an outer side 214, and the lower yoke portion 220 comprises an inner side 222 and an outer side 224. The upper portion 210 comprises a stack or collection of packets 250, while the lower portion 260 comprises a similar stack or collection of packets 260. Both the collection of packets 250 and the collection of packets 260 are built up or arranged in a stack, with each packet having a predefined height, and each stack having a predefined height. In one arrangement, the stack or collection of packets may comprise a grouping of seven packets. Of course, as those of ordinary skill in the art will recognize, groupings of different numbers may be used, such as groups of four, which are used herein for ease of description and illustration. Each of the packet collections 250, 260 comprises a plurality of packets or groupings of pre-annealed amorphous ribbon, such as the pre-annealed amorphous ribbon discussed and disclosed in WO 2011/060546 herein entirely incorporated by reference. Each of the remaining assembly components (i.e., the first and second outer legs 230, and 240 and the middle leg 250) will have similar stacking constructions.

The packet collections 250, 260 each have a unitary construction and are trapezoidal in shape. In each of the packet collections 250, 260, opposing ends of the packets 250, 260 may be mitered at oppositely-directed angles of about 45 degrees thereby providing the packets 250, 260 with major and minor sides. Preferably, the packets 250, 260 have the same width to provide the upper portion 210 with a rectangular cross-section and the packets 260 have the same width to provide the lower portion 260 with a rectangular cross-section. However, the lengths of the packets 260 are not all the same and the lengths of the packets 250 are not all the same. More specifically, the lengths within each group of packet collection 260 are different. The packet groupings 250, 260 have varying widths so as to provide the first and second outer legs 220, 240 with cruciform cross-sections. The packet groupings of the remaining amorphous ribbon assembly components will have similar cruciform cross-sectional constructions.

A V-shaped upper notch 270 may be formed in each of the packets 250 of the upper yoke portion 210 thereby defining an upper interior edge portion 272. In a similar fashion, a V-shaped lower notch 280 may be formed in each of the packets 260 of the lower portion 220 thereby defining a lower interior edge 282.

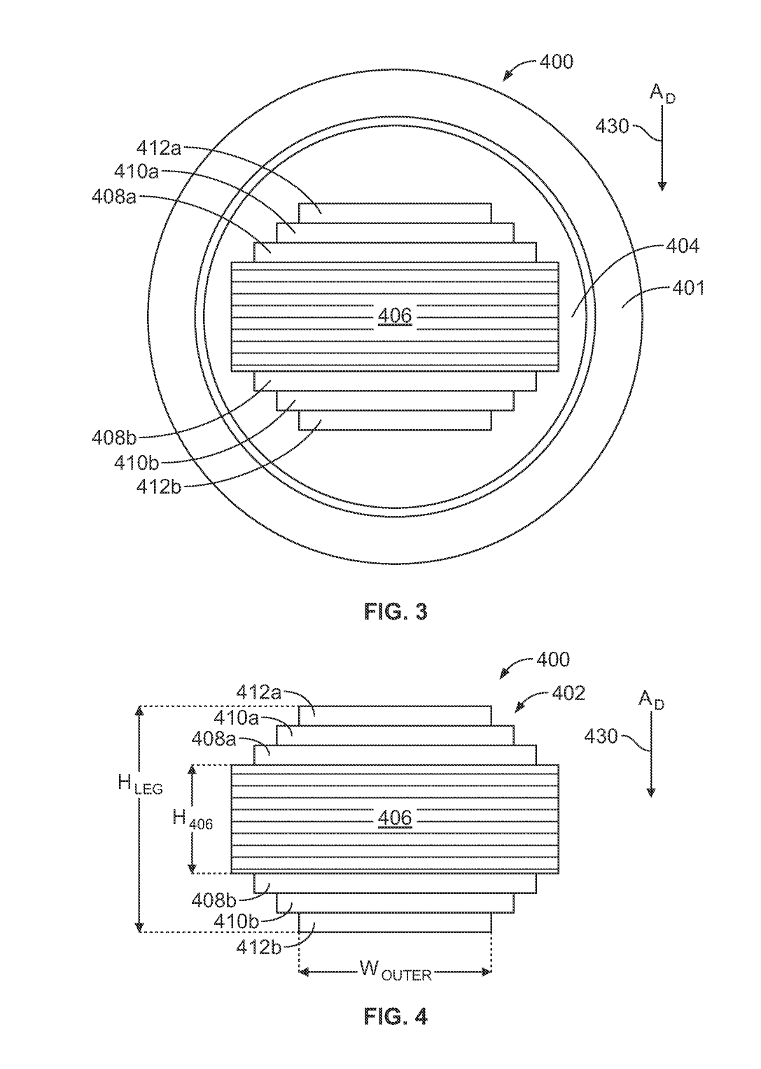

Preferably, the plurality of packets or groupings in the amorphous strip assemblies 210, 220, 230, 240, and 250 are fabricated into a crucifix configuration. For example, FIG. 3 illustrates a cross-sectional view 400 of an amorphous ribbon build up 402 for use in a stacked transformer core, such as the core illustrated in FIG. 2. In addition, FIG. 4 illustrates a cross-sectional view of one arrangement showing the core steps placed within a circular coil 401 of a transformer, such as the transformer illustrated in FIG. 1. In the stacked cores used for core-form transformers, as illustrated in FIG. 1, the three coils 102, 104, 106 each comprise circular cylinders that surround the core legs 230, 250, 240, respectively. As illustrated in FIG. 4, the core is stacked in steps, which approximates a circular cross section as shown in FIG. 4. In addition, the space between the core and an inner surface 404 of the coil 401 is needed to provide insulation clearance for the voltage difference between the winding and the core, which is at ground potential. This space is also used to accommodate the cooling medium, such as oil, so as the cool the core and the inner coil.

FIG. 4 illustrates the cross-sectional view 400 of the amorphous ribbon build up 402 illustrated in FIG. 3 but with the coil 401 (FIG. 4) removed. With reference now to FIGS. 3 and 4, as can be seen, the packets are stacked or arranged in various steps, resulting in a circular core shape that gives the windings optimum redial support. Specifically, in this illustrated arrangement, the amorphous ribbon build up 402 comprises seven stacked amorphous strip packets 406, 408a,b, 410a,b and 412a,b. This amorphous ribbon build up is configured such that these various packets, in a top to bottom direction illustrated by arrow A_{D} 430, first successively increase in width and, then after a middle tiered step 406, successively decrease in width. For example, the amorphous strip packets 408a,b are stacked adjacent to the middle tiered step 406. Preferably, the width and height of corresponding packets 408a,b are mirror images of one another. Similarly, the amorphous strip packets 410a,b are stacked on adjacent packets 408a,b, respectively. In a similar fashion, amorphous strip packets 410a,b are mirror images on one another as well.

The stacked layers 406-412 each comprise one or more groups of packet. Preferably, each stacked layer comprises 15-30 pre-annealed amorphous metallic ribbons. In one preferred arrangement, each amorphous metallic ribbon in the packet is separated from an adjacent ribbon by a distance equivalent to a predetermined stacking factor. This distance may be defined by an amount of a stacking material (i.e., an adhesive or an epoxy) placed at or along a predetermined area of the metallic ribbon. Alternatively, only certain amorphous metallic ribbons within the packet are separated from one another by such a predetermined stacking factor. The thickness of the various sections 406-412a,b in the stacking direction may vary. For example, as shown, the mid-plane section 406 may be (but not necessarily) thicker than the other packet sections 408-412a,b.

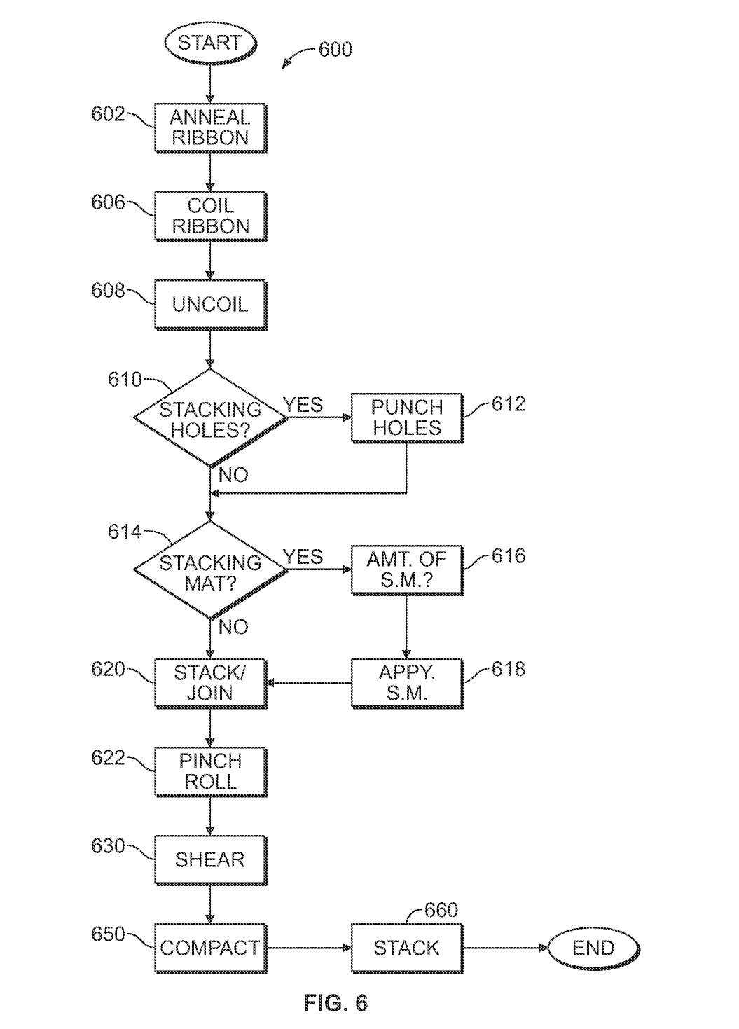

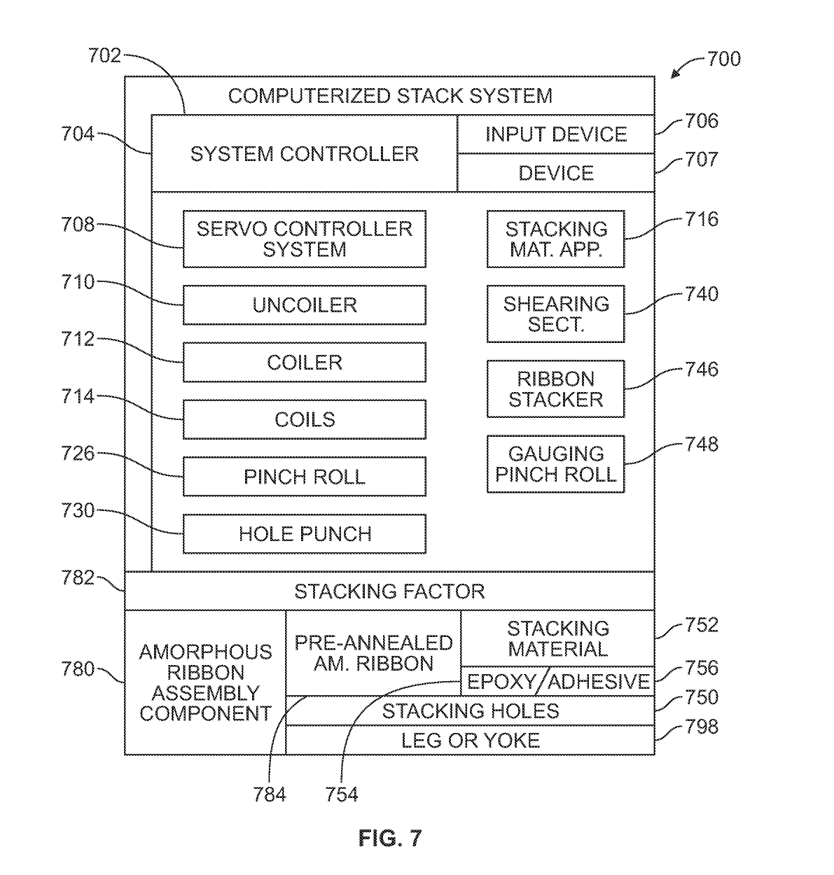

The following describes one preferred method for fabricating an amorphous ribbon assembly component for use with a stacked amorphous core, such as the stacked amorphous core 200 illustrated in FIGS. 1 and 2. For example, FIG. 6 illustrates one exemplary flow chart 600 illustrating certain process steps that may be undertaken for fabricating a stacked annealed amorphous core comprising a plurality of stacked packets or groups of pre-annealed amorphous metal ribbons. In addition, FIG. 7 is a diagram illustrating a computerized stacking system for fabricating a stacked amorphous ribbon assembly component for use in a stacked amorphous transformer core.

Referring now to FIGS. 6 and 7, the stacking system 702 includes one or more coils of pre-annealed amorphous metal ribbons, an uncoiler 710, a hole punch 730, an stacking material applicator 716, a shearer station 740, and a ribbon stacker 746. All or some of these components may be operated under control by a series of commands that are received from a processor-based system controller 708. Alternatively, the processor based controller may control the various process components by means of a manually controlled input device 706 (a mouse) such as a keyboard, mouse, joystick, other similar peripheral, or a combination thereof. A system display 707 may also be provided.

In one preferred arrangement, this system controller 704 can be used commands the to unwind the pre-annealed amorphous metallic ribbons and it can be used to command the various other component parts in the stacking system 702 to deposit, align, cut, apply stacking material, advance compress, stack, and arrangement, the amorphous ribbon assembly components as discussed herein. As just one example, the system controller 704 may be programmed to operate the shearing station 740 to shear a collection of pre-annealed amorphous ribbon and also deposit a desired amount of stacking material 752 along the metallic ribbons so as to define an overall stacking factor of the to be fabricated amorphous ribbon assembly component (i.e., the desired yoke or the desired leg). It can also be programmed to stack the correct number of ribbons in each of the stacks of the assembly component and length of ribbons as well. For instance, the required amount of stacking material 752 and the number of plies of metallic ribbon 784 in each packet may be determined from an engineering definition of the core structure being formed. The engineering definition may define surface geometry including the number of steps in the stack, step height, and overall stacking factor or height of the core as well. The engineering definition may also define the amount of stacking material 752 to be applied and the location of the applied material 752 as well.

Returning to FIG. 6, initially, at process Step 602, one or more coils 714 of amorphous ribbon is annealed, such as using the process general described above. For example, in the computerized stacking system 700 (FIG. 7), the system controller 704 may be used to control the uncoiler section 710 to uncoil the amorphous ribbon and then control the annealing process. Once the amorphous ribbon has been annealed, the system controller 704 may then re-coil the annealed amorphous ribbon back onto one or more coils 714. As such, the system controller 704 may be programmed to utilize the stacking system 702 with one or more coils of the pre-annealed amorphous ribbon 784.

Then, at process Step 606 (FIG. 6), the pre-annealed amorphous ribbon 784 is then placed back onto one or more coils. At process Step 608, the system controller 704 may then operate the uncoiler 710 so as to unwind or uncoil the pre-annealed amorphous ribbon is then unwound or uncoiled under the direction and control of the computerized stacking system 702 (FIG. 7). Specifically, the system controller 704 may provide operating instructions to the servo controller system 708 so as to vary the speed (if required) and tension (if required) during the unwinding of the pre-annealed amorphous ribbon 784 from the coils 714 during these initial unwinding steps 608 (FIG. 6). Then, at process Step 610, the system controller 704 determines weather the amorphous ribbon assembly component 780 being fabricated has been engineered or designed to include stacking holes 750 within the pre-annealed amorphous ribbon 784. If the system controller 704 determines that such stacking holes are indeed required, the system moves to process Step 612. At process Step 612, the unwound pre-annealed ribbon material 784 is then directed by the servo controller system 708 to a hole punch 730 which may then be operated under control of the system to create punch holes in the ribbon material at certain predetermined locations. After these holes are punched at process Step 612, the process returns to process Step 614.

Alternatively, if the computerized stacking system 702 at process Step 610 determines that the amorphous ribbon assembly component 780 being fabricated does not require stacking holes, then the process proceeds to process Step 614. At process Step 614, the system controller 704 determines whether a particular stacking material 752 is required for a particular packet grouping. If at process Step 614 the system proceeds to Step 616 where the system controller 704 determines that the type of stacking material 752 to be used (e.g., an epoxy 754 or an adhesive 756) and the amount of this stacking material 752 that needs to be applied to pre-annealed ribbon material so as to fabricate an amorphous ribbon assembly component 780 having the desired stacking factor.

In addition, at process Step 616, the system controller 704 will also determine the location along the amorphous ribbon of where the stacking material 752 will need to be applied. In other words, the system controller 704 will operate the servo controller system 708 such that the amorphous ribbon 784 is properly positioned in the stacker material applicator 716. For example, the processor may determine that a certain width and height of the stacking material is required and can also determine the number stacker material that will be required per amorphous stack. The system controller 704 can then calculate the amount of stacking material 752 in order to achieve the overall stacking factor of the assembly component 780 being fabricated.

As just one exemplary arrangement, placement of the adhesive may run, whether in solid strips or in a linear dot like pattern, parallel to the casting direction of the ribbon. Distortions perpendicular to the casting direction may have a negative performance effect. Adhesive can be placed perpendicular to the casting direction so as to increase rigidity, but this will come at a cost of transformer performance. As just one example, a plurality of parallel adhesive continuous lines may be provided that run parallel to the ribbon casting direction. Alternatively, a ribbon with a plurality of adhesive lines running parallel to the ribbon casting direction may be provided along with one or more unbroken lines of adhesive running transfers to the casting direction. In another arrangement, one or more of a plurality of broken lines (i.e., a lines of dots) may be provided running parallel to the ribbon casting direction. As those of ordinary skill in the art will recognize, the frequency and the size of the strips and/or dots of adhesive will be a function of the width, the length, and the thickness of the transfer core being desired along with the desire amount of rigidity. As just one example, both broken and non-broken lines of adhesive may be provided. Preferably, a stacking material 752 is selected that is capable of withstanding pressure and oil.

After the type, the amount, and the orientation of stacking material 752 is determined at process Step 616, the process returns to process Step 618. At process Step 618 the amorphous ribbons are guided under the control of the system controller 704 and the servo controller system 708 into the stacking material applicator 716 (FIG. 7) where the stacking material is applied. In one preferred arrangement, the computerized stacking system is programmed so that the pre-annealed ribbons are arranged such that the stripes of stacking material overlap one another, once they are organized in a stack by a system ribbon stacker 746 (FIG. 7). Preferably, and as discussed above, the stacking material 752 may be applied in approximately 0.025 inch wide ribbons running primarily parallel to a casting direction using a roll-transfer, tape, or other method in a thickness slightly greater than the desired thickness of the adhesive after the final stack thickness is set. Alternatively, as also described above, the stacking material 752 can be applied as small points or dots along the various predetermine ribbon locations.

After stacking material application at process Step 618, the system proceeds to Step 620. Then, at process Step 620, the collection or packet of ribbons are rejoined together, one on top of each other, by the ribbon stacker 746 (FIG. 7). Then, the controller 704 operates the servo system 78 to shuttle this initial combined stack of amorphous ribbon and stacking material combination to process Step 622 this first stack of amorphous ribbons are passed through a gauging pinch roll 726 (FIG. 7). After this initial collection of pre-assembled amorphous ribbons proceed through this pinch roll, the collection of ribbons enter a shearing station 740 (FIG. 7) at process Step 630. At this shearing station 740, this initial collection of ribbons may be cut to a predetermined length according to the design and engineering specifications of the ribbon assembly component 780. Additionally, at this process Step 630, if the system controller 704 determines that the amorphous ribbon assembly component 780 being fabricated will be used in a stacked transformer core that requires mitered edges or a v-joint as previously described above with respect to FIGS. 1 and 2, these additional shearing process steps may also take place.

After the shearing step at process Step 630, the now compressed and sheared amorphous ribbon material is propelled forward within the system 702 to process Step 650. In one arrangement, at process Step 640, the gauging pinch roll uses pneumatic, spring, or other pressure to propel the collection of material.

At process Step 650, the now initially build up and now sheared packet or collection of amorphous ribbon material enters a gauging pinch roll 748 (FIG. 7). At this gauging pinch roll which, under operation of the system controller 704 and based on previously calculated engineering and/or design criteria, is set to exert a predetermined amount of pressure or compression on this collection or packet of amorphous ribbon and stacking material so as to slightly compact this initial stack of ribbon and stacking material. The computerized servo controller system 708 of the stacking system 702 is programmed so that this stack is only compressed—except in the spots where the adhesive exists between the sheets. In these spots the stack of ribbon will be thicker—owing to the additional thickness of the stacking material between the various ribbons. The gauging pinch roll 748 is set to a maximum opening matching the exact thickness of the amorphous ribbon plus the stacking factor. As just one example, if the system is fabricating an amorphous ribbon assembly component 780 for use as the mid level grouping of packets for use as stack 406 in FIG. 4, the gauging pinch roll 748 is set to a maxim opening matching the desired, overall thickness H₄₀₆ of this desired collection of amorphous ribbon plus the stacking factor. To reduce possible linear slippage of the stack of ribbon as it passes through the gauging pinch rolls, a magnetic conveyor might be employed; whereby a magnetic force pulls the sheets against a belt having a gripping surface (rubberized, or other) to add traction to assist the ribbon collection to move through the pinch rolls without slippage. Alternatively or in addition to the magnetic conveyor, one or more profiles may be added to the surface of one of the two pinch rolls. The pressure at the points where the profile is close to the mating roll will help reduce slippage while maintaining the desired stacking factor.

One advantage of Applicants' computerized stacking system and methods as disclosed herein is that this stacking factor can be selected so as to allow the magnetorestrictive motion of the collection or packets of ribbon when magnetically energized. Compressing the overall collection of ribbon and hence the stacking material (e.g., epoxy and/or adhesive) in such a manner creates stacks of ribbon that are set to a specific, predefined thickness. As just one example, after the process Step 650, the overall height of a mid-level stack (such as the height H₄₀₆ stack 406 illustrated in FIGS. 3 and 4) would be equal to the cumulative thickness of the ribbons in the stack plus the cumulative, compressed thickness of the stacking material applied between the various ribbons. When these stacks of ribbon are then compressed in the transformer frame, as illustrated in FIG. 1, the pre-annealed amorphous ribbon will not compress any more than the predetermined stacking factor—thereby ensuring space to allow for magnetorestrictive motion.

Computer-controlled servo motors 708 that may be used for certain of the process Steps illustrated in FIG. 6 may be used to ensure that the first application of the stacking material may be placed within a predetermined distance from the each end of the ribbon collection so as to ensure that the ends are not too loose and difficult to handle and assemble. The system controller 704 may also calculate and place additional ribbons of adhesive as needed to provide rigidity to the stack. The system controller 704 may also take into account of the hole locations in the ribbons and avoid placing adhesive ribbons near or at the hole locations. Additionally, to create additional rigidity of the stack, one or more small lines of the stacking material can be applied longitudinally, in the casting direction. Once the stack is prepared at process step 650, an automated ribbon stacker 746 places the combined ribbons in a stack so as to create the desired amorphous ribbon assembly component having the desired stacking factor.

Exemplary embodiments of the present invention have been described. Those skilled in the art will understand, however, that changes and modifications may be made to these embodiments without departing from the true scope and spirit of the present invention, which is defined by the claims.

1. An amorphous ribbon assembly component for use with an amorphous metallic transformer core, the assembly component comprising;
a first collection of pre-annealed amorphous metal ribbons, and
an amount of a first stacking material provided between a first amorphous metal ribbon in the first collection of pre-annealed amorphous metal ribbons and a second amorphous metal ribbon in the first collection of pre-annealed amorphous metal ribbons, the second amorphous metal ribbon residing adjacent to the first amorphous metal ribbon;
wherein the amount of the stacking material defines a predefined stacking factor of an overall stacking height defined by the assembly component.

2. The assembly component of claim 1, wherein the assembly component comprises a transformer yoke portion.

3. The assembly component of claim 2 wherein the assembly component comprises a transformer upper yoke portion.

4. The assembly component of claim 1, wherein the assembly component comprises a transformer leg portion.

5. The assembly component of claim 1, wherein the first packet of pre-annealed amorphous metal ribbons comprises approximately 15 pre-annealed amorphous metal ribbons.

6. The assembly component of claim 1, wherein the first stacking material comprises an amount of an epoxy.

7. The assembly component of claim 6 wherein the amount of the epoxy comprises a pre-determined amount of epoxy.

8. The assembly component of claim 1, wherein the first stacking material comprises an amount of an adhesive.

9. The assembly component of claim 1, further comprising:
a second collection of pre-annealed amorphous metal ribbons, and
an amount of a second stacking material provided in between a first amorphous metal ribbon in the second collection of pre-annealed amorphous metal ribbons and a second amorphous metal ribbon residing adjacent to the first amorphous metal ribbon;
wherein the spacer defines a predefined stacking factor of an overall stacking height defined by the assembly component;
wherein the first collection of pre-annealed amorphous metal ribbons and the second collection of pre-annealed amorphous metal ribbons reside in a stacked relationship.

10. The assembly component of claim 9, wherein the first collection of pre-anneal amorphous metal ribbons are stacked on top of the second collection of pre-annealed amorphous metal ribbons.

11. The assembly component of claim 9, wherein a width of the first collection of pre-annealed amorphous metal ribbons is

[symbol]

12. The assembly component of claim 9 wherein the first stacking material comprises a different stacking material then the second stacking material.
